(19) United States
(12) Patent Application Publication
(10) Pub. No.: US 2025/0181122 A1
(43) Pub. Date: Jun. 5, 2025

(54) COMPUTER CASE

(71) Applicant: BEIJING DEEPCOOL SCI-TECH CO., LTD., Beijing (CN)

(72) Inventors: Dangsheng ZHAO, Beijing (CN); Weichao LI, Beijing (CN); Yong ZHANG, Beijing (CN); Yaojia LOU, Beijing (CN); Yijia DING, Beijing (CN)

(73) Assignee: BEIJING DEEPCOOL SCI-TECH CO., LTD., Beijing (CN)

(21) Appl. No.: 18/842,696

(22) PCT Filed: May 20, 2022
(86) PCT No.: PCT/CN2022/094078

§ 371 Date: Aug. 29, 2024

(30) Foreign Application Priority Data
May 13, 2022 (CN) 202210520583.5

(51) Int. Cl. G06F 1/18

(52) U.S. Cl. CPC G06F 1/181

(57) ABSTRACT

The present disclosure discloses a computer case that includes a case body with a first side wall and a second side wall. The first side wall and the second side wall are opposite each other; the first side wall includes a first cooling position and the second side wall includes a second cooling position. A ratio of cooling area of ventilation and cooling devices mounted at the first and second cooling positions is not less than 2:3, or a ratio of projected area of the ventilation and cooling devices mounted at the second and first cooling positions is not less than 2:3. A high-efficiency through-type airflow path may be formed inside the case body, when a guiding airflow directions of the ventilation and cooling devices mounted at the first and second cooling positions are provided to be consistent with each other. The computer case of the present disclosure may change the structural layout of the case to add more cooling positions for mounting ventilation and cooling devices so as to increase cooling area, and a more efficient through-type airflow path is formed within the case by adding positions more compatible with ventilation and cooling devices.

### CROSS-REFERENCE TO RELATED DISCLOSURES

This disclosure claims priority to Chinese Patent Application No. 202210520583.5, filed on May 13, 2022, entitled “Computer Case”, which is hereby incorporated by reference in its entirety.

### TECHNICAL FIELD

The present disclosure relates to a technical field of computer case for electronic apparatus, and more particularly, to a computer case.

### BACKGROUND

A case of a desktop computer is primarily used to securely fix a motherboard containing key devices such as a CPU, memories, a graphics card, and solid-state drives, and a power supply, mechanical hard drives, and specific peripherals therein, with external operation ports such as a power button, a reset button, and USB interfaces provided outside thereof, so that they are conveniently accessible. Therefore, a primary role of the case is to accommodate a system and provide protection thereto.

With the development of electronic information technology, the computing power of desktop computers has been significantly increased, with heat generated by CPUs, GPUs, and other system modules increased continuously. Consequently, a requirement for cooling capabilities in desktop computer systems is getting higher and higher. Thus, the computer case is further configured to carry heat exchange devices, including ventilation fans for system and water cooling radiators. Such requirement for cooling from system has raised requirements for capabilities of the computer case in ventilation and heat exchange, as well as carrying water cooling radiator systems.

As shown in FIG. 1, in the prior art, taking a case in ATX motherboard specification, which is widely used, as an example, location and specifications of the primary ventilation devices and devices with a function of ventilation and cooling are as follows: a ventilation mounting area may be provided at front and may be large enough for mounting three 120*120 mm ventilation fans or a water cooling radiator with the aforementioned three fans; a ventilation mounting area may be provided at the top and may be large enough to mount up to three 120*120 mm ventilation fans or a water cooling radiator with these fans, or may be configured to mount up to two 140*140 mm fans or a water cooling radiator with these two fans; a rear panel of the case may primarily include I/O ports of motherboard, ventilation port for power supply, and interfaces for expansion cards including graphics card. Although there is a position where a fan may be mounted at the top, there is a position for mounting ventilation device so that a fan with a maximum size of 140*140 mm or a water cooling radiator with a fan with the size as mentioned above may be mounted at this position.

The ventilation devices and heat exchange devices at these ventilation locations may all provide power for ventilation and heat exchange by means of fans. cooler air may be drawn into the case from outside, or warmer air may be expelled outside the case, depending on various needs and designs.

However, airflow paths provided in limitation and formed by positions for ventilation and heat exchange cannot form an efficient heat dissipation airflow path to expel the heat flow from the case to the outside in a timely manner due to the low compatibility of sizes and specifications of the ventilation and cooling positions.

The information disclosed in the background section is intended solely to enhance understanding of the general background of the present disclosure and should not be considered as an admission or implication that this information constitutes prior art known to those skilled in the field.

### BRIEF SUMMARY

The objective of the present disclosure is to provide a computer case, which may increase cooling area by altering structural layout of the case to add a plurality of cooling positions for mounting ventilation and cooling devices without changing the overall volume of the case approximately, and form a more efficient through-type airflow path within the case by adding positions more compatible with ventilation and cooling devices.

To achieve the above objective, the present disclosure provides a computer case that includes a case body with a first side wall and a second side wall. The first side wall and the second side wall are opposite each other, the first side wall including a first cooling position and the second side wall including a second cooling position. A ratio of cooling area of the ventilation and cooling devices mounted at the first and second cooling positions is not less than 2:3, or a ratio of projected area of the ventilation and cooling devices mounted at the second and first cooling positions is not less than 2:3. A high-efficiency through-type airflow path may be formed inside the case body, when a guiding airflow directions of the ventilation and cooling devices mounted at the first and second cooling positions are provided to be consistent with each other.

In a preferable embodiment, the first and second side walls include complete opening or a plurality of individual ventilation holes, and mounting liners are provided at edges of the complete opening or individual ventilation holes. The mounting liner has mounting holes to form the first and second cooling positions.

In another preferable embodiment, the case body further includes a top wall, a bottom plate, a lower chamber cover, and a main mounting plate. The top wall is provided at the top of the case body; the bottom plate is provided at the bottom of the case body and is detachably provided on a bottom frame; the lower chamber cover is provided between the top wall and the bottom plate; the main mounting plate is provided between the lower chamber cover and the top wall and between back edges on the same side of the first and second side walls.

In another preferable embodiment, the top wall includes a complete opening or a plurality of individual ventilation holes, and mounting liners are provided at edges of the complete opening or the plurality of individual ventilation holes. The mounting liner has mounting holes to form a third cooling position configured to mount ventilation and cooling devices.

In another preferable embodiment, the lower chamber cover includes a horizontal partition and a vertical plate; the horizontal partition is provided in parallel with the bottom plate and is between the top wall and the bottom plate, with both ends of the horizontal partition abutting the first and second side walls, respectively. The horizontal partition includes a rectangular avoidance opening provided at an abutting position where both ends of the horizontal partition abut the first and second side walls. The rectangular avoidance opening is configured to avoid the ventilation and cooling devices mounted at the first and second cooling positions. The vertical plate is provided perpendicularly to the horizontal partition and is between edges on the same side of the horizontal partition and the bottom plate; an edge of the horizontal partition on a side far from the vertical plate is fixedly connected to a lower edge of the main mounting plate.

In another preferable embodiment, the horizontal partition includes IO holes, ventilation and cooling holes, a plurality of positions for fixedly mounting PCIE expansion cards, and a plurality of detachable baffles. The IO holes are provided on a side of the horizontal partition near the main mounting plate and are provided corresponding to an IO section of the computer motherboard; the ventilation and cooling holes are provided on a side of the horizontal partition near the vertical plate, and edges of the ventilation and cooling holes have a plurality of mounting holes to form a fourth cooling position configured to mount ventilation and cooling devices. A plurality of positions for fixedly mounting PCIE expansion cards and a plurality of detachable baffles are provided on an end of the horizontal partition away from the IO holes and ventilation and cooling holes; wherein a plurality of positions for fixedly mounting PCIE expansion cards, the fourth cooling position, and IO holes are all provided on the same side of the main mounting plate facing the vertical plate.

In another preferable embodiment, the bottom plate includes a position for mounting power fan and a fifth cooling position; the position for mounting power fan is provided at an end of the bottom plate near the second side wall, and is provided with ventilation holes; the fifth cooling position is provided at an end of the bottom plate near the first side wall and at the ventilation hole at a vertical projection position of the fourth cooling position, a plurality of mounting holes are provided surrounding the ventilation holes to form the fifth cooling position configured to mount ventilation and cooling devices.

In another preferable embodiment, the case body further includes a front side wall, a rear side wall, a front panel, a rear panel, a first side panel, a second side panel, and a top plate; the front side wall is provided on a side of the case body away from the main mounting plate; the rear side wall is provided on a side of the case body near the main mounting plate; the front panel, the rear panel, the first side panel, the second side panel, and the top plate are respectively provided at the front side wall, the rear side wall, the first side wall, the second side wall, and the top plate of the case body.

In another preferable embodiment, the rear panel includes a ventilation avoidance opening for power supply and an avoidance hole for IO adapter board; the ventilation avoidance opening for power supply is provided at a ventilation and cooling panel for power supply corresponding to the power supply on a lower part of the rear panel, the ventilation and cooling panel for power supply includes a power cable socket and a power switch; the avoidance hole for IO adapter board is provided at the lower part of the rear panel and on a side of the ventilation avoidance opening for power supply, and is configured to expose the IO adapter board provided on the case body.

In another preferable embodiment, a lower part of the main mounting plate is vertical to the horizontal partition to form a first vertical surface, a lower edge of the first vertical surface is connected to the horizontal partition; wherein the fourth cooling position is provided on a side of the first vertical surface of the main mounting plate, the IO holes are provided on the other side of the first vertical surface, and the plurality of positions for fixedly mounting PCIE expansion cards are in parallel with both sides of the first vertical surface; an upper part of the main mounting plate extends obliquely towards the front side wall to form an inclined plate, and an angle between the inclined plate and the first vertical surface may be not less than 90 degrees, and the inclined plate is provided with cable routing holes; an upper edge of the inclined plate bends upward to form a second vertical surface, which is parallel to the first vertical surface, and the main mounting plate is connected to a frame of the case body via the second vertical surface.

Compared to the prior art, the computer case of the present disclosure has the following beneficial advantages: Firstly, the airflow path, which is large at front and small at back in a horizontal direction and thus has weak effect in the existing case is retained but changed to be vertical. Furthermore, with the airflow path changed to be vertical, a lower chamber suitable for ventilation may be provided between the horizontal partition and the bottom plate has. Additionally, the water cooling radiator component with a 120*120 mm (or 140*140 mm) fan that cannot be mounted adjacently to a 360*120 water cooling device in the prior art is now provided in the lower chamber under the horizontal partition, so that the water cooling device at the ventilation position and the 360 water cooling radiator adjacent to the water cooling device at a 90-degree angle may be mounted together and operate simultaneously in a case with almost same size with the case in the prior art, and eventually more water cooling devices may be mounted together and operate simultaneously, and a capacity for cooling the system may be increased. Furthermore, since the detachable bottom plate of the case at a position corresponding to a mounting position for fan or water cooling radiator of the horizontal partition is also configured to have a corresponding cooling mounting position where another corresponding ventilation fan may be mounted, so that the airflow speed entering or exiting from the bottom of the case may be increased under a combined help from fans mounted on the upper and lower surfaces of the lower chamber, and the ventilation and cooling effect may be enhanced. Additionally, compared to prior art, a complete ventilation surface of a side wall with holes is added in the computer case of the present disclosure so that up to three 120*120 mm (or two 140*140 mm) fans or water cooling radiator components in the above specifications may be mounted thereon, and thus a through-type horizontally enhanced airflow path may be formed by the ventilation surface and the ventilation and cooling devices mounted at corresponding opening opposite the ventilation surface on the side wall of the case. The opening rates of the left and right side walls of the case are highly matched in the horizontal orientation, and possible ventilation and cooling devices suitable for mounting thereon are highly matched in specifications and numbers, so that a higher ventilation efficiency may be ensured. Furthermore, with the increasing demand for water cooling, compared to the prior art, another water cooling devices with a maximum specification of 120*360 may be further provided in the computer case of the present disclosure, and the cooling capacity of the system may be greatly increased. The computer case involved in the present disclosure changes the traditional front-rear layout of the case to allow the case to be arranged along the length direction of a computer desk when being placed on the desk, and may be placed on the user's left or right side according to the user's habits or needs, the space on user's desk may be saved and visual effects and user experience may be improved.

### BRIEF DESCRIPTION OF THE DRAWINGS

FIG. 1 is a schematic diagram illustrating arrangement of cooling positions on the front, rear, and top of a computer case according to an embodiment of the prior art;

FIG. 2 is a schematic structural diagram of the top of a computer case according to an embodiment of the prior art;

FIG. 3 is a schematic structural diagram of the rear of a computer case according to an embodiment of the prior art;

FIG. 4 is a schematic structural diagram of the front panel of a computer case according to an embodiment of the prior art;

FIG. 5 is an exploded structural diagram of a computer case at a perspective view according to an embodiment of the present disclosure;

FIG. 6 is another exploded structural diagram of a computer case at a perspective view according to an embodiment of the present disclosure;

FIG. 7 is a perspective exploded structural diagram of a case body at a perspective view according to an embodiment of the present disclosure;

FIG. 8 is another perspective exploded structural diagram of a case body at a perspective view according to an embodiment of the present disclosure;

FIG. 9 is a rear structural view of a case body according to an embodiment of the present disclosure;

FIG. 10 is a front structural view of a case body according to an embodiment of the present disclosure;

FIG. 11 is an enlarged partial structural diagram at position I in FIG. 7;

FIG. 12 is an enlarged partial structural diagram at position II in FIG. 8;

FIG. 13 is a schematic diagram of airflow orientation at front of a computer case according to an embodiment of the present disclosure;

FIG. 14 is a schematic diagram of airflow orientation at rear of a computer case according to an embodiment of the present disclosure;

FIG. 15 is another schematic diagram of airflow orientation at rear of a computer case according to an embodiment of the present disclosure;

FIG. 16 is a schematic layout diagram (I) of the horizontal partition according to an embodiment of the present disclosure;

FIG. 17 is a schematic layout diagram (II) of the horizontal partition according to an embodiment of the present disclosure;

FIG. 18 is a schematic structural diagram of the rear panel of a computer case according to an embodiment of the present disclosure;

FIG. 19 is a schematic layout structural diagram of the detachable bottom plate according to an embodiment of the present disclosure;

FIG. 20 is a schematic structural diagram of the main mounting plate from a rear view according to an embodiment of the present disclosure;

FIG. 21 is a schematic structural diagram of the main mounting plate from a front view according to an embodiment of the present disclosure;

FIG. 22 is a schematic structural diagram of the main mounting plate from a right view according to an embodiment of the present disclosure;

### REFERENCE NUMBERS

10—computer case, 101—case body, 1011—first cooling position, 1012—second cooling position, 1013—third cooling position, 1014—main mounting plate, 1015—lower compartment cover, 10151—fourth cooling position, 10152—IO holes, 10153—position for fixedly mounting PCIE expansion card, 10154—horizontal partition, 10155—vertical panel, 1016—power component, 10161—ventilation and cooling panel for power supply, 1017—IO adapter board, 1018—first vertical surface, 1019—inclined plate, 1020—second vertical surface, 102—front panel, 103—rear panel, 1031—ventilation avoidance opening for power supply, 1032—avoidance hole for IO adapter board, 1033—ventilation hole for graphics card, 104—first side panel, 105—second side panel, 1061—base plate, 10611—fifth cooling position, 10612—power fan mounting position, 1062—bottom frame, 107—top plate, 20—ventilation and cooling device.

### DETAILED DESCRIPTION

Detailed description would be made below on embodiments of the present disclosure in conjunction with the attached FIGs. However, it should be understood that the scope of the present disclosure is not limited to these embodiments.

Unless otherwise explicitly stated, the terms “comprises” or variations such as “includes” or “contains” in the description and claims should be understood to mean the inclusion of the stated elements or components, without excluding other elements or components.

It is well known that in a cooling system, if fans located at different positions drive air in the same direction, a directional enhanced ventilation path may be formed within the case. The hotter air inside the case may be expelled more efficiently under the action of the path formed by the fans, and cooler external air may enter the case system more efficiently, so that better air circulation may be formed eventually. Under the same internal resistance (the resistance affecting airflow formed by devices inside the case), the heat exchange efficiency of the ventilation path depends on the airflow and air pressure formed by the fans and the matching degree of air intake and outgoing at both ends of the path.

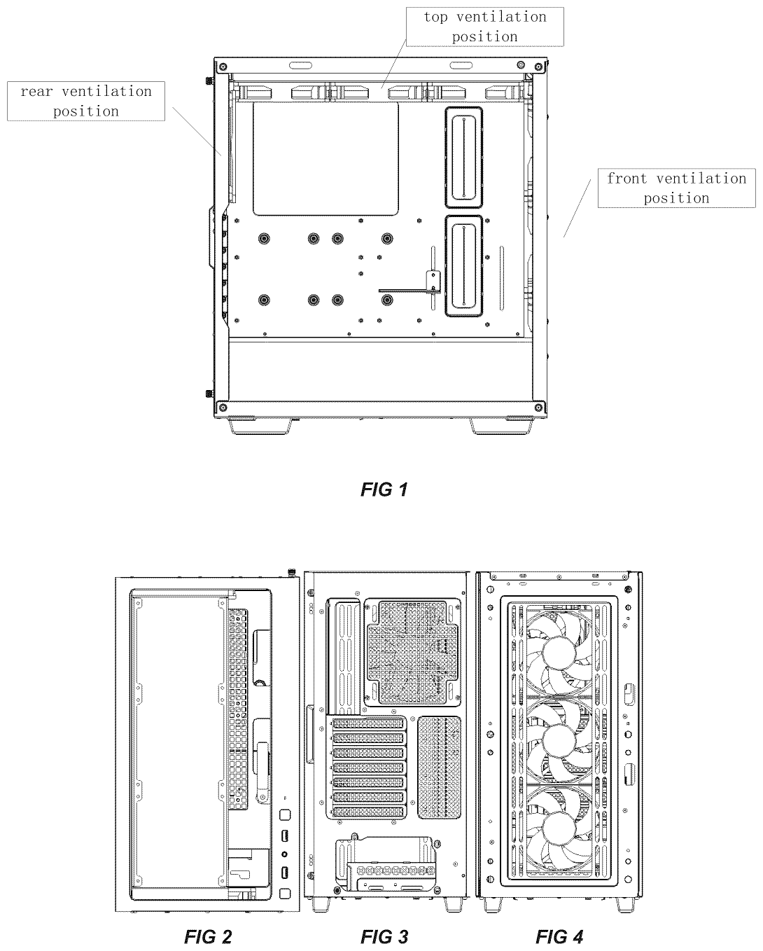

As shown in FIGS. 2 to 4, and also referring to FIG. 1, in the prior art, three 120*120 mm fans at front and one 120*120 mm (or 140*140 mm) fan at rear of an ATX case are located on two corresponding surfaces of a cuboid-like case, to form an enhance airflow path under action by operations in the same direction of fans. This airflow path is also the only intake and outgoing path that can be formed in an ATX case in the prior art. However, a matching degree of this path is very low, and only one fan of the three fans at front corresponding to the rear may form a relatively weak path, which has a low exhaust efficiency, and the system's heat exchange efficiency may be significantly affected.

Regarding the specifications for water cooling radiators suitable for mounting, the ATX case in the prior art may mount two 360*120 mm (or two 140*280 mm) and one 120 mm (or up to 140 mm) water cooling radiators. However, due to the volume limitation of conventional ATX case, the 120*120 mm or 140*140 mm water cooling radiator at rear cannot be installed together with the 360 or 280 water cooling radiator at top, since the water cooling radiator at rear contains space required for water chambers and inlet/outlet pipes. Thus, a cooling combination consisted of a 360*120 mm water cooling radiator at front, a 360*120 mm water cooling radiator at top, and a 120*120 mm or 140*140 mm fan at rear may be obtained at most. Considering the developments of demands on cooling computer systems, there are needs for water cooling for power supply components of mainboard, SSDs, and even power supply elements which may generate heat in addition to the current CPU and GPU cards. It is difficult for the specifications available for mounting water cooling radiator in the prior art to meet future demands on cooling computer.

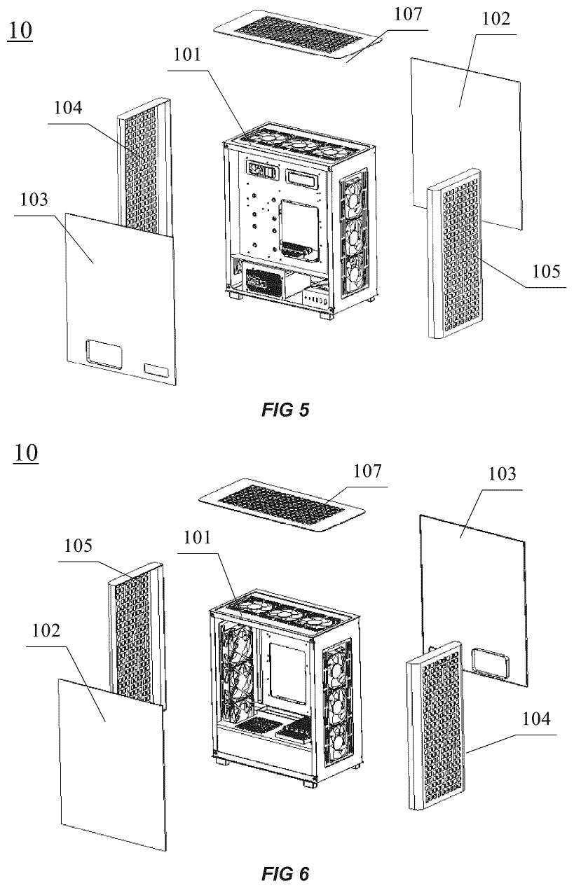

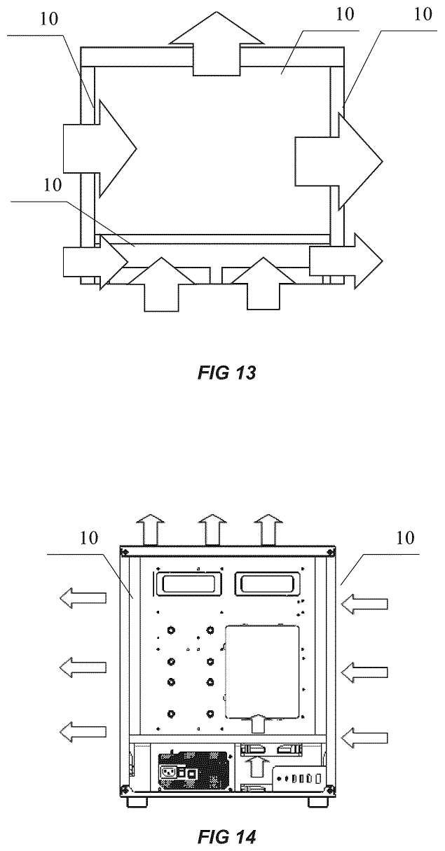

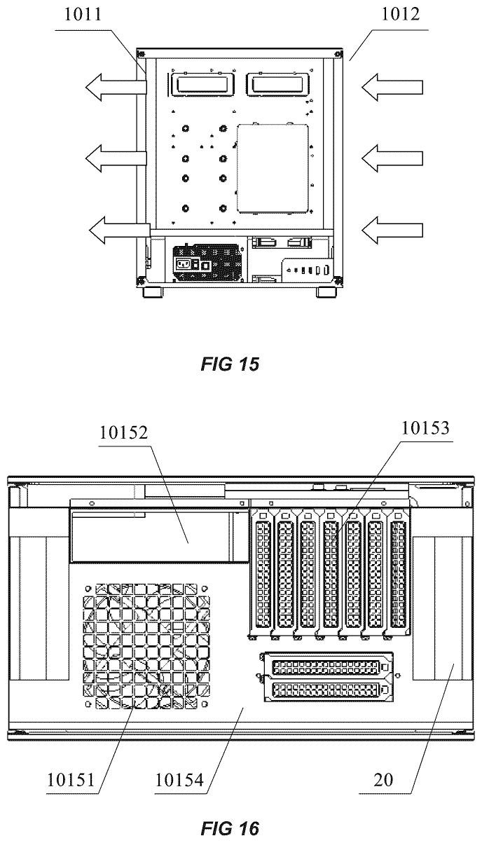

As shown in FIGS. 5, 6, and 12, 13, 14, 15, according to a preferred embodiment of the present disclosure, a computer case 10 may include a case body 101 with a first side wall (commonly referred as a front side wall in the prior art) and a second side wall (commonly referred as a rear side wall in the prior art). The first side wall and the second side wall are opposite each other. The first side wall includes a first cooling position 1011 and the second side wall includes a second cooling position 1012. A ventilation and cooling device 20 may be mounted at the first cooling position 1011 and the second cooling position 1012. A through-type horizontal airflow guiding path may be formed inside the case body 101, when a guiding airflow directions of the ventilation and cooling device 20 are consistent with each other.

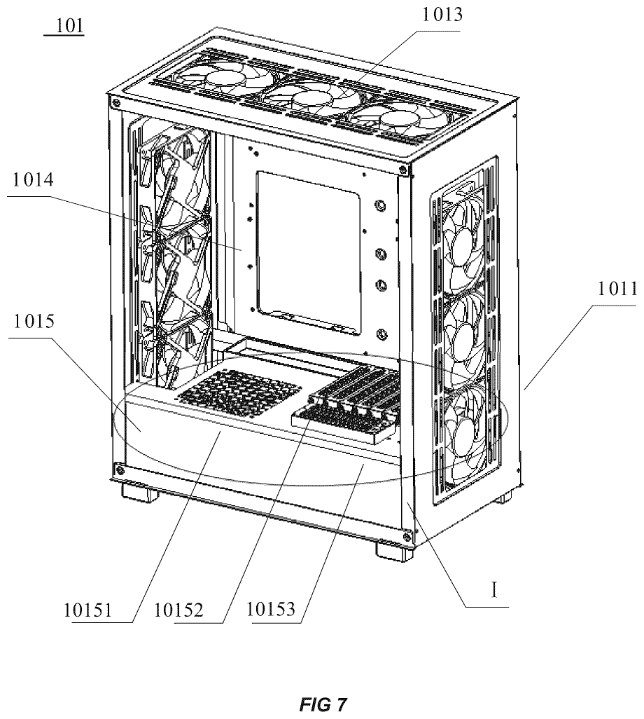

As shown in FIGS. 7 and 10, in some embodiments, the first and second side walls include complete opening or a plurality of individual ventilation holes, and mounting liners are provided at edges of the complete opening or individual ventilation holes and has mounting holes thereon. The mounting holes configured to form the first cooling positions 1011 and the second cooling positions 1012. The first cooling positions 1011 and the second cooling positions 1012 may be configured to mount the ventilation and cooling device 20. The ventilation and cooling device 20 may generally include a water cooling radiator and a fan component or the like.

In some embodiments, the first cooling positions 1011 and the second cooling positions 1012, which has an area almost equal to 100% the areas of the first and second side walls, may be formed on the first and second side walls, after complete holes are formed on the first and second side walls. The ventilation and cooling device 20, which may occupy 100% the cooling area of the first cooling positions 1011 and the second cooling positions 1012, may be mounted at the first cooling positions 1011 and the second cooling positions 1012. A projected cooling area of the ventilation and cooling device 20 may be e.g., but not limited to, ½ or ⅔ of the area of the first cooling positions 1011 and the second cooling positions 1012, rather than 100% the cooling area of the first cooling positions 1011 and the second cooling positions 1012. However, in order to form an effective through-type guiding airflow path inside the case body, the projected cooling area of the ventilation and cooling device 20 mounted at the first cooling positions 1011 and the second cooling positions 1012 may be preferably not less than ½ of the area of the first cooling positions 1011 and the second cooling positions 1012, and a ratio of projected area of the ventilation and cooling device 20 mounted at first cooling position 1011 and projected area of the ventilation and cooling device 20 mounted at second cooling position 1012 is preferably not less than 2:3.

Refer to FIG. 7 and FIG. 10, in some embodiments, the case body 101 may further include a top wall, a bottom plate 1061, a lower chamber cover 1015, and a main mounting plate 1014. The top wall is provided at the top of the case body 101. The bottom plate 1061 is provided at the bottom of the case body 101. The lower chamber cover 1015 is provided between the top wall and the bottom plate 1061. The main mounting plate 1014 is provided between the lower chamber cover 1015 and the top wall and between back edges on the same side of the first and second side walls.

Refer to FIG. 7 and FIG. 10, in some embodiments, the top wall may include a complete opening or a plurality of individual ventilation holes, and mounting liners may be provided at edges of the complete opening or the plurality of individual ventilation holes. The mounting liner may be provided with mounting holes thereon, and the mounting holes may be configured to form a third cooling position 1013. The third cooling position 1013 may be configured to mount ventilation and cooling device 20. The third cooling position 1013A is illustrated to have a ventilation and cooling device 20 mounted thereon in the present embodiment, but the third cooling position 1013 may be provided with or without ventilation and cooling device 20 as needed, and there is no limitation thereby in the present disclosure.

As shown in FIG. 1 and FIG. 12, with reference to FIG. 7 and FIG. 10, in some embodiments, the lower chamber cover 1015 may include a horizontal partition 10154 and a vertical plate 10155. The horizontal partition 10154 is provided in parallel with the bottom plate 1061 and is between the top wall and the bottom plate 1061, while both ends of the horizontal partition 10154 abut the first and second side walls, respectively. The horizontal partition 10154 may include a rectangular avoidance opening, which may be provided at an abutting position where both ends of the horizontal partition 10154 abut the first and second side walls. The rectangular avoidance opening may be configured to avoid the ventilation and cooling device 20 mounted at the first cooling position 1011 and the second cooling position 1012. The vertical plate 10155 may be provided perpendicularly to the horizontal partition 10154 and may be located between edges on the same side of the horizontal partition 10154 and the bottom plate 1061. An edge of the horizontal partition 10154 on a side away from the vertical plate 10155 is fixedly connected to a lower edge of the main mounting plate 1014.

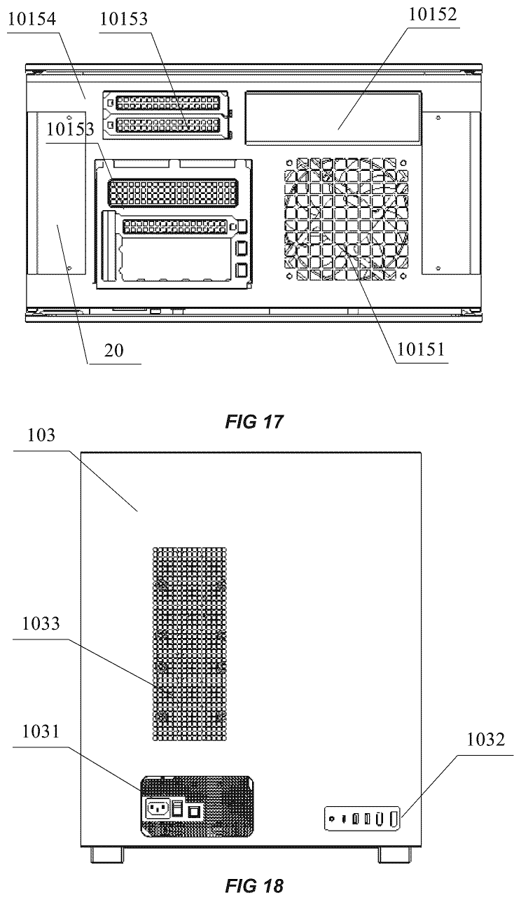

As shown in FIG. 16 and FIG. 17, in some embodiments, the horizontal partition 10154 may include IO holes 10152, ventilation and cooling holes, a plurality of positions 10153 for fixedly mounting PCIE expansion cards, and a plurality of detachable baffles. The IO holes 10152 may be provided on a side of the horizontal partition 10154 near the main mounting plate 1014 and are provided corresponding to an IO section of the computer motherboard. The ventilation and cooling holes may be provided on a side of the horizontal partition 10154 near the vertical plate 10155, and edges of the ventilation and cooling holes may have a plurality of mounting holes to form fourth cooling positions 10151, which may be configured to mount ventilation and cooling devices 20. A plurality of positions 10153 for fixedly mounting PCIE expansion cards and a plurality of detachable baffles may be provided on an end of the horizontal partition 10154 away from the IO holes 10152 and ventilation and cooling holes. As shown in FIG. 16, a plurality of positions 10153 for fixedly mounting PCIE expansion cards, the fourth cooling positions 10151, and IO holes 10152 are all provided on the same side of the main mounting plate 1014 facing the vertical plate 10155.

As shown in FIG. 17, the fourth cooling positions 10151 may be provided on the same side of the main mounting plate 1014 facing the vertical plate 10155, while the IO holes 10152 may be provided on the opposite side. A plurality of positions for fixedly mounting PCIE expansion cards may be provided in parallel to both sides of the vertical plate 10155. Therefore, the positions 10153 for fixedly mounting PCIE expansion cards may be distributed in parallel on both sides of the main mounting plate 1014, and one side may be close to the front panel 102 and the other side may be close to the rear panel 103. The front panel 102 and rear panel 103 may form two separated vertical spaces with the main mounting plate 1014, so that graphics cards may be mounted in corresponding positions on each side to implement an arrangement for mounting dual graphics cards so as to meet higher demands on graphics processing.

Refer to FIG. 16 and FIG. 17, in some embodiments, the horizontal partition 10154 may be provided in various forms in the vertical direction. Only two forms are shown in FIG. 16 and FIG. 17 in the present embodiment, but the present disclosure is not limited to these. In some embodiments, the positions 10153 for fixedly mounting PCIE expansion cards and IO holes 10152 may be provided in parallel in the length direction.

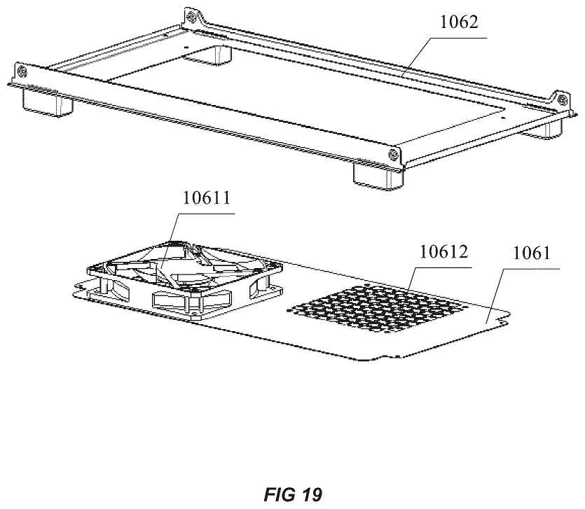

As shown in FIG. 19, in some embodiments, a bottom frame 1062 of the case body 101 may be integrally fixed with the case body 101, and the bottom plate 1061 may be detachably provided on the bottom frame 1062. The bottom plate 1061 may include a position 10612 for mounting power fan and a fifth cooling position 10611. The position 10612 for mounting power fan may be provided at an end of the bottom plate 1061 near the second side wall, and may be provided with ventilation holes. The fifth cooling position 10611 may be provided at an end of the bottom plate 1061 near the first side wall and at the ventilation hole at a vertical projection position of the fourth cooling position 10151. A plurality of mounting holes may be provided around the ventilation holes to form the fifth cooling position 10611. The fifth cooling position 10611 may be configured to mount ventilation and cooling devices 20. Four supports may be fixedly connected to the bottom of the bottom frame 1062 and the bottom plate 1061 so that the entire case body 101 may be elevated from the surface of desktop to form a ventilation path under the bottom plate 1061 of the case body 101.

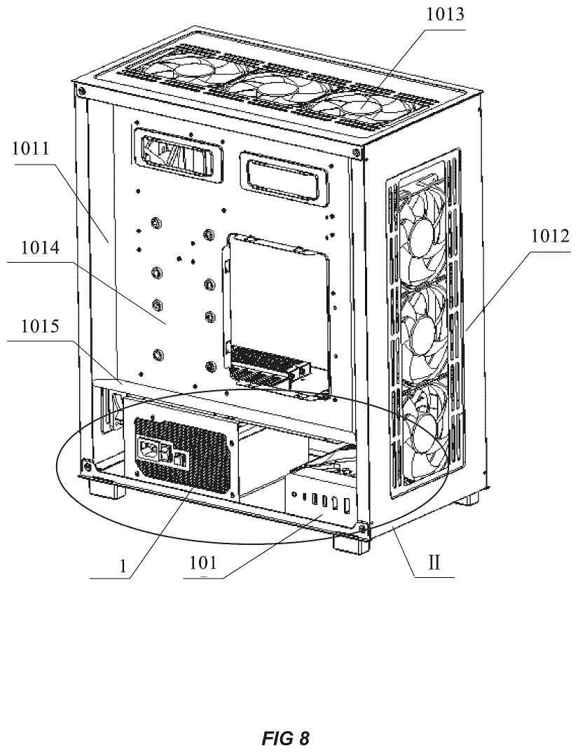

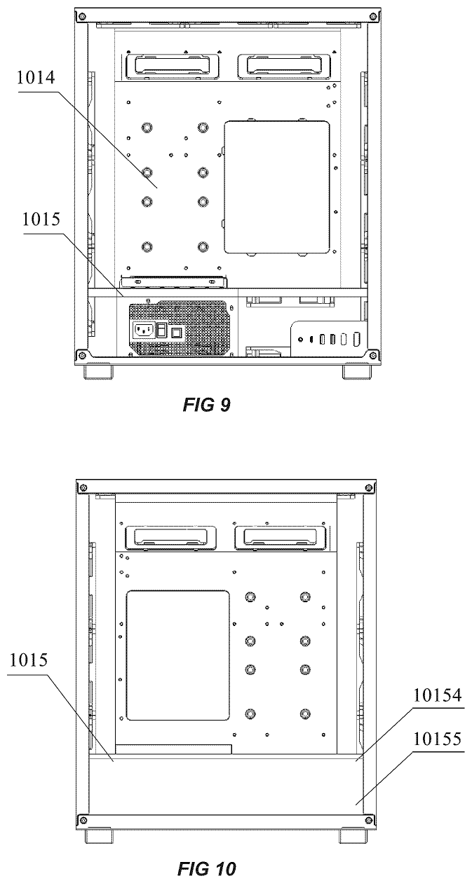

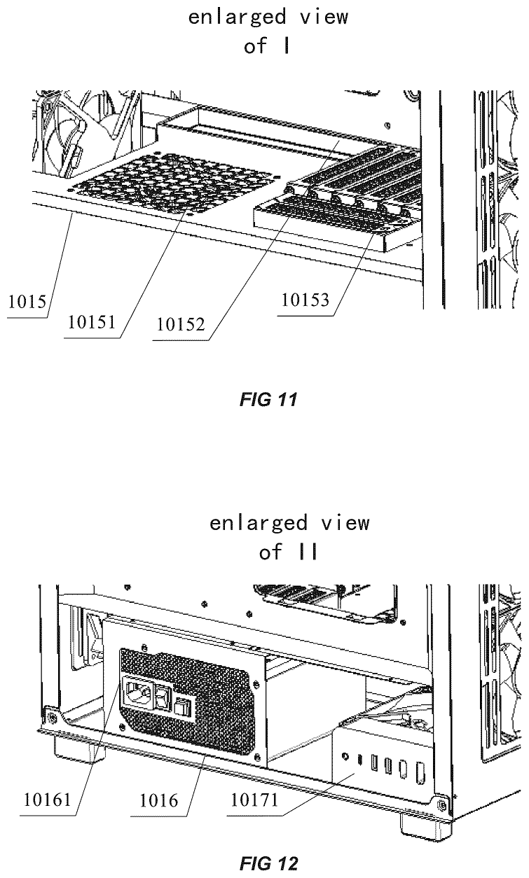

Refer to FIG. 5 to FIG. 10, in some embodiments, the case body 101 may further include a front side wall, a rear side wall, a front panel 102, a rear panel 103, a first side panel 104, a second side panel 105, and a top plate 107. The front side wall may be provided on a side of the case body 101 away from the main mounting plate 1014. The rear side wall may be provided on a side of the case body 101 near the main mounting plate 1014. The front panel 102, the rear panel 103, the first side panel 104, the second side panel 105, and the top plate 107 may be respectively provided at the front side wall, the rear side wall, the first side wall, the second side wall, and the top plate of the case body 101. The front panel 102, the rear panel 103, the first side panel 104, the second side panel 105, and the top plate 107 may be generally provided with ventilation and cooling holes therein.

As shown in FIG. 18, in some embodiments, the rear panel 103 may include a ventilation avoidance opening 1031 for power supply and an avoidance hole 1032 for IO adapter board. The ventilation avoidance opening 1031 for power supply may be provided at a ventilation and cooling panel for power supply corresponding to the power supply on a lower part of the rear panel 103. The ventilation and cooling panel for power supply may include a power cable socket and a power switch thereon. The avoidance hole 1032 for IO adapter board may be provided at the lower part of the rear panel 103 and on a side of the ventilation avoidance opening 1031 for power supply, and may be configured to expose the IO adapter board provided on the case body 101. In some embodiments, the rear panel 103 may be provided with ventilation holes for graphics card vertically extending at a position corresponding to the positions 10153 for fixedly mounting PCIE expansion cards, to facilitate the cooling for graphics card vertically mounted at the position 10153.

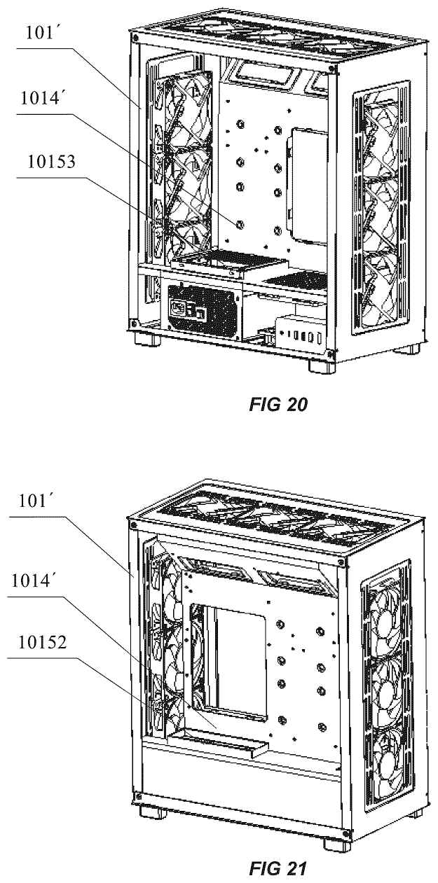

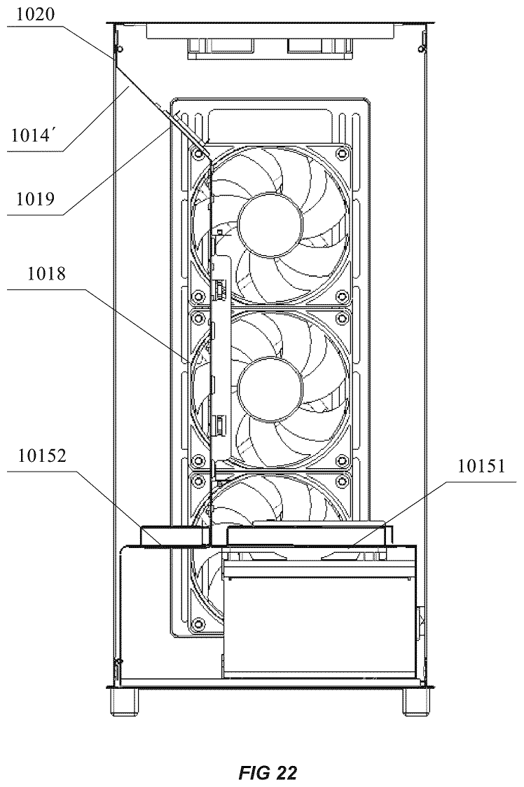

As shown in FIG. 20 to FIG. 22, another embodiment of a case body 101′ is illustrated. In some embodiments, a main mounting plate 1014′ is not an integral planar structure, and a lower part of the main mounting plate 1014′ may be provided vertically to the horizontal partition 10154 to form a first vertical surface 1018. A lower edge of the first vertical surface 1018 may be connected to the horizontal partition 10154. The fourth cooling position 10151 and the plurality of positions 10153 for fixedly mounting PCIE expansion cards may be provided on the same side of the first vertical surface of the main mounting plate 1014′, while the IO holes 10152 may be provided on the other side of the first vertical surface 1018. Furthermore, an upper part of the main mounting plate 1014′ extends obliquely towards the front side wall to form an inclined plate 1019, and an angle between the inclined plate 1019 and the first vertical surface 1018 may be not less than 90 degrees. The inclined plate 1019 may be provided with cable routing holes. An upper edge of the inclined plate 1019 may bend upward to form a second vertical surface 1020, which is parallel to the first vertical surface 1018. The main mounting plate 1014′ may be connected to a frame of the case body 101 via the second vertical surface 1020.

In summary, the computer case of the present disclosure may have the following advantages: Firstly, the airflow path, which is large at front and small at back in a horizontal direction and thus has weak effect in the existing case is retained but changed to be vertical. Furthermore, with the airflow path changed to be vertical, a lower chamber suitable for ventilation may be provided between the horizontal partition and the bottom plate has. Additionally, the water cooling radiator component with a 120*120 mm (or 140*140 mm) fan that cannot be mounted adjacently to a 360*120 water cooling device in the prior art is now provided in the lower chamber under the horizontal partition, so that the water cooling device at the ventilation and cooling position and the 360 water cooling radiator adjacent to the water cooling device at a 90-degree angle may be mounted together and operate simultaneously in a case with almost same size with the case in the prior art, and eventually more water cooling devices may be mounted together and operate simultaneously, and a capacity for cooling the system may be increased.

Furthermore, since the bottom plate of the case at a position corresponding to a mounting position for fan or water cooling radiator of the horizontal partition is also configured to have a corresponding fan mounting position where another corresponding ventilation fan may be mounted, so that the flow of air sucked into the bottom of the case or expelled out of the bottom of the case may be increased under a combined help from fans mounted on the upper and lower surfaces of the lower chamber, and the ventilation and cooling effect may be enhanced.

Additionally, compared to prior art, a complete ventilation surface of a side wall with holes is added in the computer case of the present disclosure so that up to three 120*120 mm (or two 140*140 mm) fans or water cooling radiator components in the above specifications may be mounted thereon, and thus an enhanced through-type horizontally enhanced airflow path may be formed by the ventilation surface and the ventilation and cooling devices mounted at corresponding opening opposite the ventilation surface on the side wall of the case.

The opening rates of the left and right side walls of the case are highly matched in the horizontal orientation, and possible ventilation and cooling devices suitable for mounting thereon are highly matched in specifications and numbers, so that a higher ventilation efficiency may be ensured. Furthermore, with the increasing demand for water cooling, compared to the prior art, another water cooling devices with a maximum specification of 120*360 may be further provided in the computer case of the present disclosure, and the cooling capacity of the system may be greatly increased. The computer case involved in the present disclosure changes the traditional front-rear layout of the case to allow the case to be arranged along the length direction of a computer desk when being placed on the desk, and may be placed on the user's left or right side according to the user's habits or needs, the space on user's desk may be saved and visual effects and user experience may be improved.

The description of exemplary embodiments of the present disclosure is for illustrative purposes. Such description is not intended to limit the disclosure to the specific forms as disclosed, and it is obvious that many modifications and variations can be made in light of the above teachings. The purpose of selecting and describing exemplary embodiments is to explain the particular principles of the disclosure and its practical applications, enabling those skilled in the art to implement and utilize various exemplary embodiments and various choices and modifications of the disclosure. The scope of the disclosure is intended to be defined by the claims and their equivalents.

1. A computer case, comprising:
a case body, which comprises a first side wall and a second side wall, the first side wall and the second side wall being opposite each other, the first side wall comprising a first cooling position and the second side wall comprising a second cooling position, a ratio of cooling area of ventilation and cooling devices mounted at the first and second cooling positions is not less than 2:3, or a ratio of projected area of the ventilation and cooling devices mounted at the second and first cooling positions is not less than 2:3;
wherein a high-efficiency through-type airflow path is formed inside the case body, when a guiding airflow direction of the ventilation and cooling devices mounted at the first and second cooling positions are configured to be consistent with each other.

2. The computer case according to claim 1, wherein, the first and second side walls comprises a complete opening or a plurality of individual ventilation holes, and mounting liners are provided at edges of the complete opening or the individual ventilation holes, the mounting liner is provided with mounting holes to form the first and second cooling positions.

3. The computer case according to claim 1, wherein, the case body further comprises:
a top wall, provided at top of the case body;
a bottom plate, provided at bottom of the case body and detachably provided on a bottom frame;
a lower chamber cover, provided between the top wall and the bottom plate;
a main mounting plate, provided between the lower chamber cover and the top wall and between back edges on the same side of the first and second side walls.

4. The computer case according to claim 3, wherein, the top wall comprises a complete opening or a plurality of individual ventilation holes, and mounting liners are provided at edges of the complete opening or the plurality of individual ventilation holes, the mounting liner is provided with mounting holes to form a third cooling position configured to mount ventilation and cooling devices.

5. The computer case according to claim 3, wherein, the lower chamber cover comprises:
a horizontal partition, provided in parallel with the bottom plate and located between the top wall and the bottom plate, with both ends of the horizontal partition abutting the first and second side walls, respectively, the horizontal partition comprises a rectangular avoidance opening provided at an abutting position where both ends of the horizontal partition abut the first and second side walls, the rectangular avoidance opening is configured to avoid the ventilation and cooling devices mounted at the first and second cooling positions; and
a vertical plate, provided perpendicularly to the horizontal partition and located between edges on the same side of the horizontal partition and the bottom plate;
wherein an edge of the horizontal partition on a side away from the vertical plate is fixedly connected to a lower edge of the main mounting plate.

6. The computer case according to claim 5, wherein, the horizontal partition comprises:
IO holes, provided on a side of the horizontal partition near the main mounting plate and provided corresponding to an IO section of the computer motherboard;
ventilation and cooling holes, provided on a side of the horizontal partition near the vertical plate, and edges of the ventilation and cooling holes are provided with a plurality of mounting holes to form a fourth cooling position configured to mount ventilation and cooling devices; and
a plurality of positions for fixedly mounting PCIE expansion cards and a plurality of detachable baffles, provided on an end of the horizontal partition away from the IO holes and ventilation and cooling holes.

7. The computer case according to claim 6, wherein, the plurality of positions for fixedly mounting PCIE expansion cards, the fourth cooling position, and the IO holes are all provided on the same side of the main mounting plate facing the vertical plate.

8. The computer case according to claim 3, wherein, the bottom plate comprises:
a position for mounting power fan, provided at an end of the bottom plate near the second side wall, and provided with ventilation holes; and
a fifth cooling position, provided at an end of the bottom plate near the first side wall and at a ventilation hole at a vertical projection position of the fourth cooling position, a plurality of mounting holes are provided around the ventilation holes to form the fifth cooling position configured to mount ventilation and cooling devices.

9. The computer case according to claim 7, wherein, the case body further comprises:
a front side wall, provided on a side of the case body away from the main mounting plate;
a rear side wall, provided on a side of the case body near the main mounting plate;
a front panel, a rear panel, a first side panel, a second side panel, and a top plate, respectively provided at the front side wall, the rear side wall, the first side wall, the second side wall, and the top plate of the case body.

10. The computer case according to claim 9, wherein, the rear panel comprises:
a ventilation avoidance opening for power supply, provided at a ventilation and cooling panel for power supply corresponding to a power supply on a lower part of the rear panel, the ventilation and cooling panel for power supply comprises a power cable socket and a power switch; and
an avoidance hole for IO adapter board, provided at the lower part of the rear panel and on a side of the ventilation avoidance opening for power supply, and configured to expose the IO adapter board provided on the case body.

11. The computer case according to claim 6, wherein, a lower part of the main mounting plate is vertical to the horizontal partition to form a first vertical surface, a lower edge of the first vertical surface is connected to the horizontal partition;
wherein the fourth cooling position is provided on a side of the first vertical surface of the main mounting plate, the IO holes are provided on the other side of the first vertical surface, and the plurality of positions for fixedly mounting PCIE expansion cards are in parallel with both sides of the first vertical surface;
an upper part of the main mounting plate extends obliquely towards the front side wall to form an inclined plate, and an angle between the inclined plate and the first vertical surface is not less than 90 degrees, and the inclined plate is provided with cable routing holes;
an upper edge of the inclined plate bends upward to form a second vertical surface, which is parallel to the first vertical surface, and the main mounting plate is connected to a frame of the case body via the second vertical surface.
